(19) United States
(12) Patent Application Publication
(10) Pub. No.: US 2025/0354955 A1
(43) Pub. Date: Nov. 20, 2025

(54) CARTRIDGE FOR CAPILLARY ELECTROPHORESIS

(71) Applicant: DH Technologies Development Pte. Ltd., Singapore (SG)

(72) Inventors: Brian D. PETERSON, Ontario, CA (US); Ohm GRITTE, Brea, CA (US); Ronald FRANCK, Irvine, CA (US)

(73) Assignee: DH Technologies Development Pte. Ltd., Singapore (SG)

(21) Appl. No.: 18/871,844

(22) PCT Filed: Jun. 7, 2023
(86) PCT No.: PCT/IB2023/055894

§ 371 Date: Dec. 5, 2024

Related U.S. Application Data
(60) Provisional application No. 63/350,899, filed on Jun. 10, 2022.

(51) Int. Cl. G01N 27/447

(52) U.S. Cl. CPC G01N 27/44708

(57) ABSTRACT

A cartridge 300 for capillary electrophoresis includes a housing which includes a base 202 at least partially defining a cavity 250 defining a cavity volume. A cover plate 304 that is secured to the base 202 defines a window. A volume displacement structure 360 projects from at least one of the base 202 and the cover plate 304 and into the cavity 250 when the cover plate is secured to the base. The volume displacement structure 360 and cavity 250 together at least partially define a coolant liquid flow path 366 having a coolant liquid flow path volume less than the cavity volume. A plurality of capillaries 326 is disposed in the coolant liquid flow path. Each of the plurality of capillaries includes a capillary inlet 222 and a capillary outlet 224 projecting from the base.

### CROSS-REFERENCE WITH RELATED APPLICATIONS

This application is being filed on Jun. 7, 2023, as a PCT International Patent Application that claims priority to and the benefit of U.S. Provisional Application No. 63/350,899, filed on Jun. 10, 2022, which disclosure is hereby incorporated by reference in its entirety.

### INTRODUCTION

Capillary electrophoresis (CE) is often employed for rapid separation and analysis of charged species. Current instruments can typically analyze only one sample at a time (e.g., using a single capillary), which limits the instrument's throughput. Temperature of a capillary environment may affect reproducibility, accuracy, repeatability, and/or robustness of CE analysis. Thus, thermal control over capillary environment is desirable, especially for instruments that can analyze more than one sample at a time (e.g., using a plurality of capillaries). Cartridges used for capillary electrophoresis include one or more capillaries that transfer liquids for analysis. Heat generated within the analysis instrument may adversely affect the liquid within the capillaries; as such, thermal control within the cartridge is desirable. Such control is often difficult to maintain, however, causing hot spots within the cartridge and variations in temperature that can lead to errors and issues with analysis.

### SUMMARY

In one aspect, the technology relates to a cartridge for capillary electrophoresis including: a housing including: a base at least partially defining a cavity defining a cavity volume; a cover plate secured to the base, wherein the cover plate defines a window; and a volume displacement structure projecting from at least one of the base and the cover plate and into the cavity when the cover plate is secured to the base, wherein the volume displacement structure and cavity together at least partially define a coolant liquid flow path having a coolant liquid flow path volume less than the cavity volume; and a plurality of capillaries disposed in the coolant liquid flow path, wherein each of the plurality of capillaries includes a capillary inlet and a capillary outlet projecting from the base. In an example, the cavity is defined by an outer curved wall. In another example, the volume displacement structure projects from the cover and is disposed adjacent the outer curved wall. In yet another example, the volume displacement structure projects from the cover and is spaced apart from the outer curved wall. In still another example, the cartridge further includes a thermally-conductive chip aligned with the window, wherein the thermally-conductive chip defines a plurality of grooves, wherein each of the plurality of grooves is configured to receive one of the plurality of capillaries.

In another example of the above aspect, the thermally-conductive chip is spaced apart from the base so as to form at least a portion of the coolant liquid flow path between the base and the thermally-conductive chip. In an example, the base further defines a coolant liquid inlet in fluid communication with the cavity and a coolant liquid outlet in fluid communication with the cavity. In another example, the coolant liquid flow path defines a substantially consistent height between the base and the cover plate. In yet another example, the coolant liquid flow path defines a width in a direction substantially orthogonal to the height, and wherein an inlet width proximate the coolant liquid inlet is greater than an outlet width proximate the coolant liquid outlet. In still another example, the cartridge further includes at least one detent projecting from the base.

In another aspect, the technology relates to a system for supplying liquid to an electrophoresis cartridge, the system includes: a dock including: a coolant liquid supply conduit; a flow distributor fluidically coupled to the coolant liquid supply conduit, wherein the flow distributor includes a plurality of vanes; a coolant liquid return conduit; and an interface plate for interfacing with the electrophoresis cartridge, the interface plate including: a face for contacting the electrophoresis cartridge; a coolant liquid supply port defined by the face and in fluid communication with the flow distributor; and a coolant liquid return port defined by the face and in fluid communication with the coolant liquid return conduit. In an example, the coolant liquid supply port is adjacent the coolant liquid return port. In another example, the flow distributor includes an inlet end including an inlet width and an outlet end including an outlet width. In yet another example, each of the plurality of vanes includes a leading end and a trailing end. In still another example, the leading ends of at least two of the plurality of vanes are disposed different distances from the inlet end.

In another example of the above aspect, the trailing ends of a plurality of the plurality of vanes are disposed at substantially similar distances from the outlet end. In an example, the flow distributor includes an upper surface and a lower surface, and wherein each of the plurality of vanes contact both the upper surface and the lower surface along an entire length of each of the plurality of vanes. In another example, the flow distributor includes a unitary part disposed in the dock. In yet another example, the unitary part defines the coolant liquid supply conduit and the coolant liquid return conduit. In still another example, a width of the outlet end of the flow distributor is greater than a width of the inlet end of the flow distributor

### BRIEF DESCRIPTION OF THE DRAWINGS

FIG. 1A is a block diagram illustrating select components of an analysis instrument, in accordance with an example.

FIG. 1B is a perspective views of select internal components of another analysis instrument, such as the instrument of FIG. 6, along with an electrophoresis cartridge in accordance with an example.

FIGS. 2A-2B are partial rear and front perspective views, respectively, of an electrophoresis cartridge, in accordance with an example.

FIGS. 3A-3B are exploded rear perspective and front views, respectively, of the electrophoresis cartridge of FIGS. 2A-2B.

FIGS. 4A-4B are exploded rear perspective and front views, respectively, of an electrophoresis cartridge, in accordance with another example.

FIG. 5A is an enlarged partial view of an observation window portion of the electrophoresis cartridge of FIGS. 2A-2B.

FIG. 5B is an enlarged partial perspective sectional view of the observation window portion of the electrophoresis cartridge of FIGS. 2A-2B.

FIG. 6 is a perspective view of an analysis instrument receiving an electrophoresis cartridge.

FIG. 7 is a partial view of a dock for an analysis instrument.

FIG. 8 is a top sectional view of the dock of FIG. 7.

### DETAILED DESCRIPTION

The technologies described herein include a multi-capillary cartridge that utilizes liquid cooling. The cartridge body forms a coolant liquid flow path that has a shape that tracks the shape in which the capillaries are positioned within the coolant liquid flow path. The length and layout of the capillaries in some respects, dictates the dimensions of the coolant liquid flow path. For example, the capillaries are separated apart near the inlet and are bundled together on the outlet. The shape of the coolant liquid flow path narrows from the inlet to the outlet. This causes the heat removal rate to increase gradually as the coolant liquid flow path narrows and coolant flow velocity increases in sync with the convergence of the capillaries. The cartridge may also include a thermally-conductive chip at an observation window thereof. One surface of the chip is in contact with the portions of the capillaries located at the detection window. The chip acts as a heat sink to draw heat away from the capillaries at the observation window. Past an opposite surface of the chip from the capillaries, the coolant liquid flows at maximum velocity through the narrowest section of the coolant liquid flow path. This helps maintain thermal regulation proximate the observation window. In an example, the chip has V-grooves that retain the capillaries, which are spaced at 500 μm center-to-center on the chip. The chip defines windows that are elongate rectangular in shape with a height of 3 mm (along the axis of each capillary), and with a width of 100 μm. Within the analysis instrument, a dock with a flow distributor that ensures uniform heat regulation within the cartridge during an analysis procedure. Certain other features of the cartridge prevent leakage of the coolant liquid, ensure proper docking, prevent damaging the capillaries, etc. These may include, e.g., male/female separation features, rearward and forward legs, etc.

It will be understood that, although the terms first, second, etc. may be used herein to describe various elements, these elements should not be limited by these terms. These terms are only used to distinguish one element from another element. Thus, for example, a first element, a first component, or a first section discussed below could be termed a second element, a second component, or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners without departing from the teachings of the present disclosure.

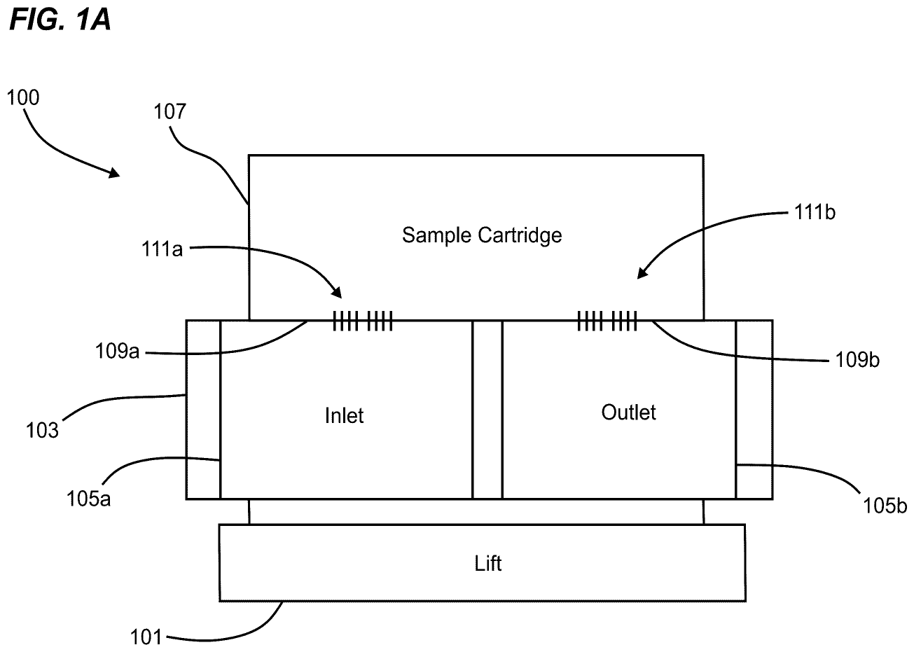

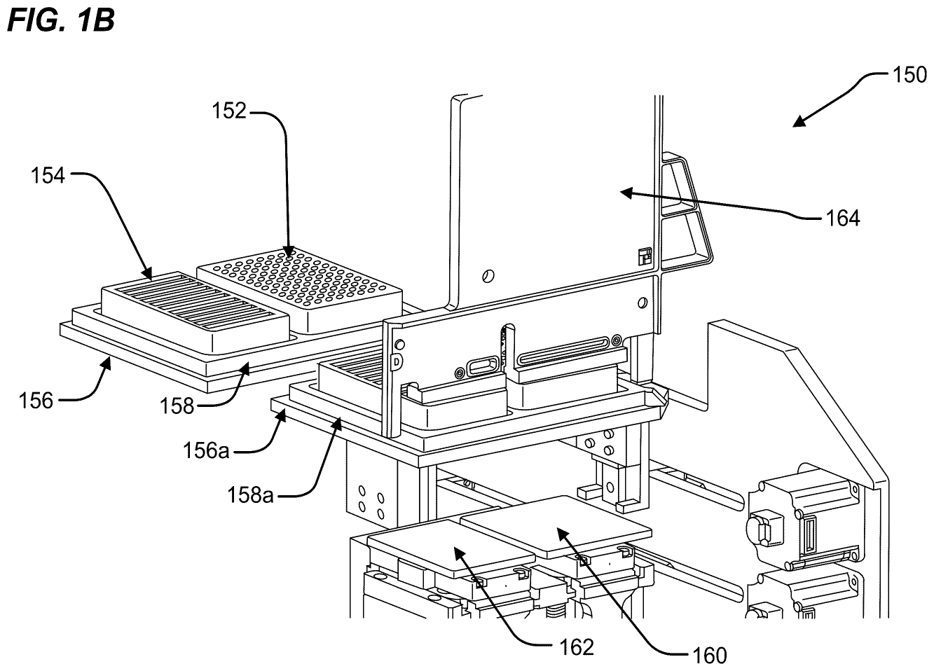

FIG. 1A is a block diagram illustrating select components of an analysis instrument 100, in accordance with an example. For illustrative purposes and context, the instrument 100 may include a lift 101, a tray holder 103, an inlet tray 105A, an outlet tray 105B, and a sample or electrophoresis cartridge 107. Sealing interfaces 109A and 109B are also shown between the inlet and outlet trays 103 and 105, and the sample cartridge 107. The inlet tray 105A may include a one or more sample reservoirs for providing fluid samples to conduits in the sample cartridge 107. In one example, the conduits may be capillaries. Similarly, the outlet tray 105B may comprise a plurality of cavities for providing a force, pressure difference, or vacuum, to the containers in the sample cartridge 107 to force the fluid into the containers. The inlet and outlet trays 105A, 105B may be microplates.

In an example, the sealing surfaces 109A and 109B may be separate for the inlet and outlet trays 105A and 105B with the trays being held in a single tray holder 103 and both being made against the same sample cartridge 107. Two different mechanisms in the lift 101 press the trays, within the tray holder 103, against the cartridge 107. One mechanism may be centered below the inlet tray 105A, the other below the outlet tray 105B, as illustrated. In operation, the instrument 100 may provide sample material into conduits in the sample cartridge 107. In an example scenario, the containers in the sample cartridge 107 may comprise capillaries that are coupled to the inlet and outlet trays 105A and 105B via nozzles or similar tubes. The inlet side nozzles 111A may be at a higher pressure and the outlet side nozzles 111B under action of a force, pressure difference, or vacuum, for example, to create a force to move liquid from the inlet tray 105A into the capillaries.

FIG. 1B illustrates select internal components of another analysis instrument 150. An inlet tray 152 and an outlet tray 154 are depicted, as are tray holders 156 and 156a. Tray locks 158, 158a hold their respective inlet trays 152 and outlet trays 154. Moving platforms or lifts 160 and 162 may apply pressure or force independently to the inlet tray 152 and to the outlet tray 154 so that each may be sealed against the bottom surface of the couplable upper member or cartridge 164. Further details of the sample cartridge 164 are shown with respect to the following figures.

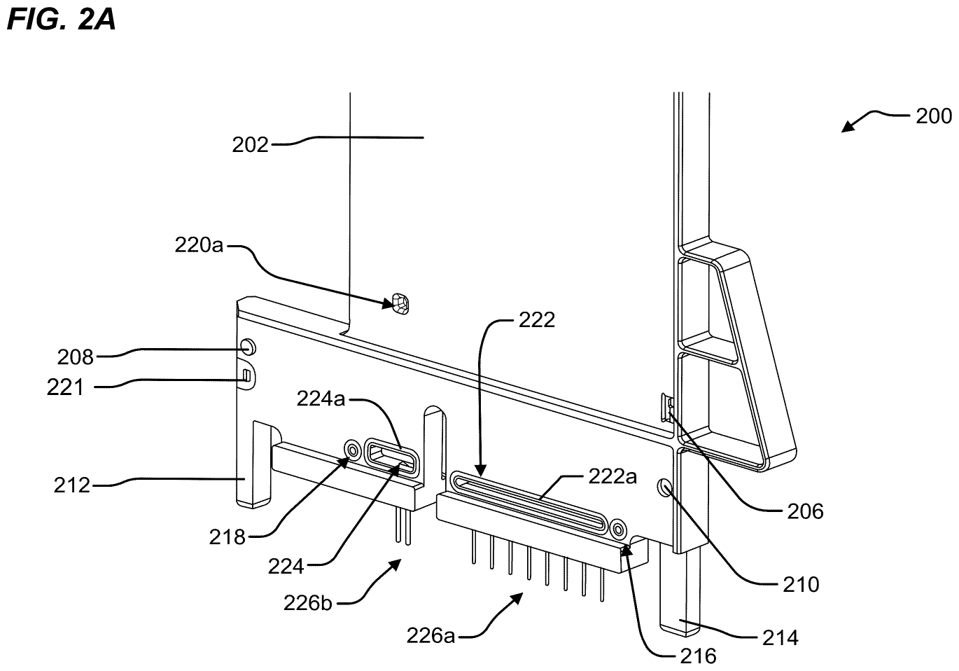

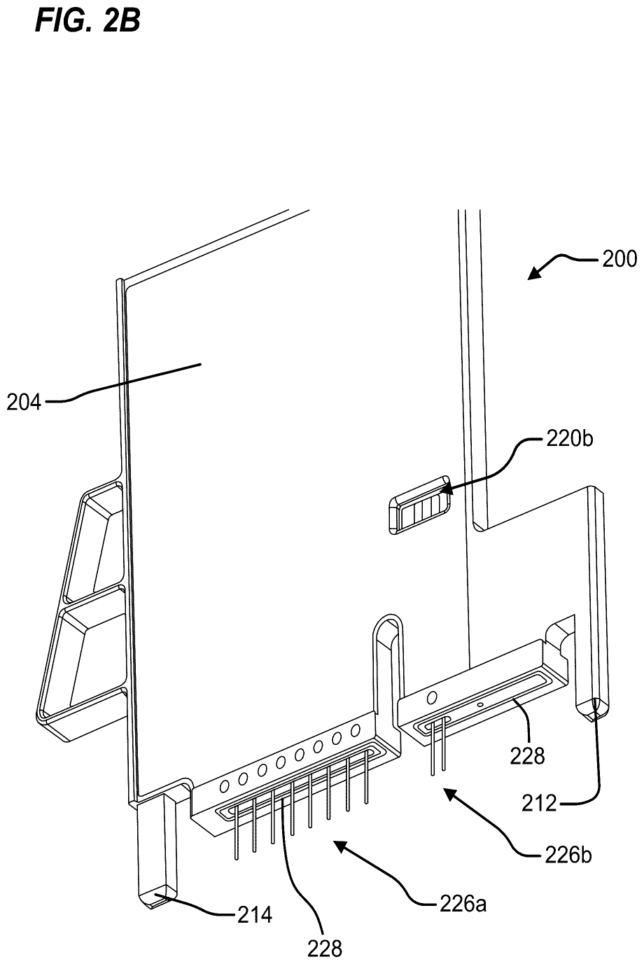

FIGS. 2A-2B are partial rear and front perspective views, respectively, of an electrophoresis cartridge 200, in accordance with an example. FIGS. 2A-2B are described concurrently and not all components thereof are depicted in both figures. The cartridge 200 includes a housing formed from a base 202 and a cover plate 204 secured thereto, as described herein. The cartridge 200 may include an identification memory chip 206. The memory chip 206 may be read by a corresponding reader in the analysis instrument, a cartridge storage system, or other system that may store, manipulate, or otherwise analyze the cartridge 200 or contents thereof. Information contained on the memory chip 206 may include, but is not necessarily limited to, cartridge type, run counter, serial number, etc. One or more male separation feature(s) 208 (e.g., in the form of a post or protrusion) may extend from the base 202 to maintain a separation between the cartridge 200 and a corresponding side of a dock, described below. When the cartridge 200 is fully inserted into an analysis instrument, the protrusion 208 will align with a corresponding feature on the dock allowing the two planar surfaces of the dock and the cartridge 200 to make contact. A female separation feature 210 is a pocket feature to maintain a separation between the cartridge 200 and a corresponding side of the dock. When the cartridge 200 is fully inserted into the analysis instrument, the pocket 210 will align with a protrusion feature on the dock, allowing the two planar surfaces to make contact. These separation features help prevent damage to the liquid and air seals, described in further detail below.

A rearward leg 212 and a forward leg 214 protrude from the cartridge 200 to assist in guiding the cartridge 200 into the analysis instrument. The legs 212, 214 also protect capillaries (described below) when the cartridge 200 is not installed in an instrument (e.g., during movement or storage). An inlet air port 216 allows air pressure to or from the inlet tray wells to be adjusted. As noted above, when pressurized, liquid may flow from the inlet tray wells and into the capillaries. Similarly, an outlet air port 218 allows air pressure to be adjusted to or from the outlet tray wells. A retention detent 221 provides the user with tactile (and/or audible) feedback when the cartridge 200 is fully inserted into an instrument. An excitation window 220a is defined by the base 202 of the housing and allows incoming radiation to access each capillary contained within the cartridge 200. Light is projected into a excitation window 220a, passes through the capillaries within the cartridge; the excitation window is aligned with a detection window 220b. Absorption and fluorescence detection is utilized for the analysis.

The base 202 also defines a coolant liquid inlet 222 through which the coolant liquid flows into the cartridge 200. The flow of coolant liquid has a relatively even distribution along its length, due to a configuration of components within the dock, as described below. The coolant liquid inlet 222 is surrounded by a seal or gasket 222a that seals the inlet 222 against the docking interface, though in examples, a seal or gasket may additionally or alternatively be provided on a corresponding surface of the dock. Similarly, the base also defines a coolant liquid outlet 224 where the coolant liquid exits the cartridge 200 and returns to a liquid heat exchanger in the instrument. A seal or gasket 224a is disposed around the outlet 224. Capillary inlets 226a are also depicted. One to eight or more capillary inlets 226a, each surrounded by a cannula electrode, may be utilized. A corresponding number of capillary outlets 226b are also depicted. The capillary outlets 226b may be bundled close together, and typically include a single electrode for the bundle. Seals 228 surround the groups of capillary inlets 226a and capillary outlets 226b.

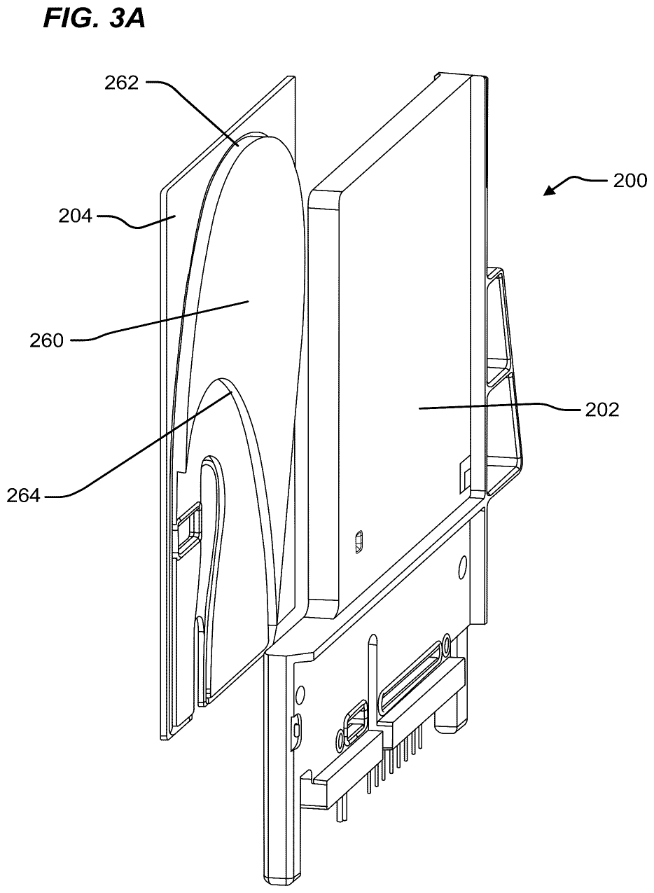

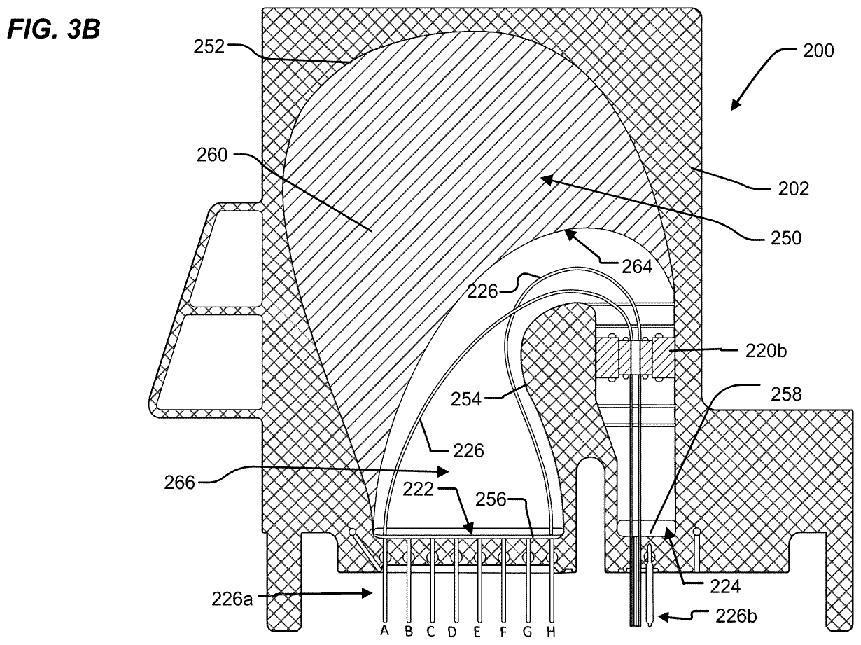

FIGS. 3A-3B are exploded rear perspective and front views, respectively, of the electrophoresis cartridge 200 of FIGS. 2A-2B. FIGS. 3A-3B are described concurrently and not every feature is depicted in both figures. Further, certain features are described in more detail with regard to FIGS. 2A-2B above. The cartridge 200 includes a base 202 and a cover plate 204 secured thereto in a liquid-tight manner, e.g., via mechanical, chemical, friction fit, or other fasteners or combinations thereof. The cover plate 204 is depicted as transparent for illustrative purposes; in examples, it may be opaque, transparent, translucent, or combinations thereof. The base 202 defines a cavity 250 that is defined at least in part by an outer curved wall 252, an inner curved wall 254, an inlet wall 256, and an outlet wall 258. The heights of the various walls are generally consistent between the base 202 and cover plate 204; thus, the various walls, base 202, and cover plate 204 define a cavity volume of the cavity 250. A volume displacement structure 260 projects from the cover plate 204 and has a height substantially consistent with that of the various walls of the cavity 250. Thus, the volume displacement structure 260 projects into the cavity 250, so as to fill a portion of the cavity volume. This reduces the total volume available for coolant liquid flow within the cavity 250 and, depending on the configuration of the volume displacement structure 260, can ensure a relatively consistent coolant liquid flow at various locations distant from the inlet wall 256 (which is located proximate the inlet 222). Outlet wall 258 is located proximate the outlet 224.

In FIGS. 3A-3B, the volume displacement structure 260 is defined by a first wall 262 and a second wall 264. With the cover plate 204 secured to the base 202, the first wall 262 is adjacent the outer curved wall 252 and the second wall 264 defines the outermost extent of coolant liquid flow within the cavity 250. In FIG. 3B, the second wall 264 is depicted as a dashed line. Thus, in the cartridge 200 of FIGS. 3A-3B, the second wall 264, the inner curved wall 254, the inlet wall 256, and the outlet wall 258 define a coolant liquid flow path 266 having a liquid flow path volume that is less than the cavity volume. Capillary inlets 226a (labeled A-H) are depicted, as are bundled capillary outlets 226b. Within the coolant liquid flow path 266, only two of the eight capillaries 226 are depicted for clarity and each capillary 226 has a nominal length of about 30 cm. As can be seem most prominently in FIG. 3B, the coolant liquid flow path 266 decreases in width from the inlet wall 256 (proximate the inlet 222) towards the outlet wall 258 (proximate the outlet 224). As the height (between the base 202 and the cover plate 204) of the coolant liquid flow path 266 is generally consistent along the entire volume thereof, and the volumetric flow of coolant liquid remains constant, the coolant flow velocity increases from the inlet 222 to the outlet 224. As the capillaries 226 are disposed closer together further along their lengths (e.g., towards the outlet 224), this increased coolant liquid velocity helps control temperature within the cartridge 200 and at each of the capillaries 226. FIGS. 3A-3B also depict the detection window 220b, details of which are described further below. It should be noted, however, that the capillaries 226 are disposed adjacent to each other at the detection window 220b, with axes thereof substantially aligned along a single plane. At this location, the liquid flow path 266 is fairly narrow, helping to ensure high speed coolant liquid flow at this location.

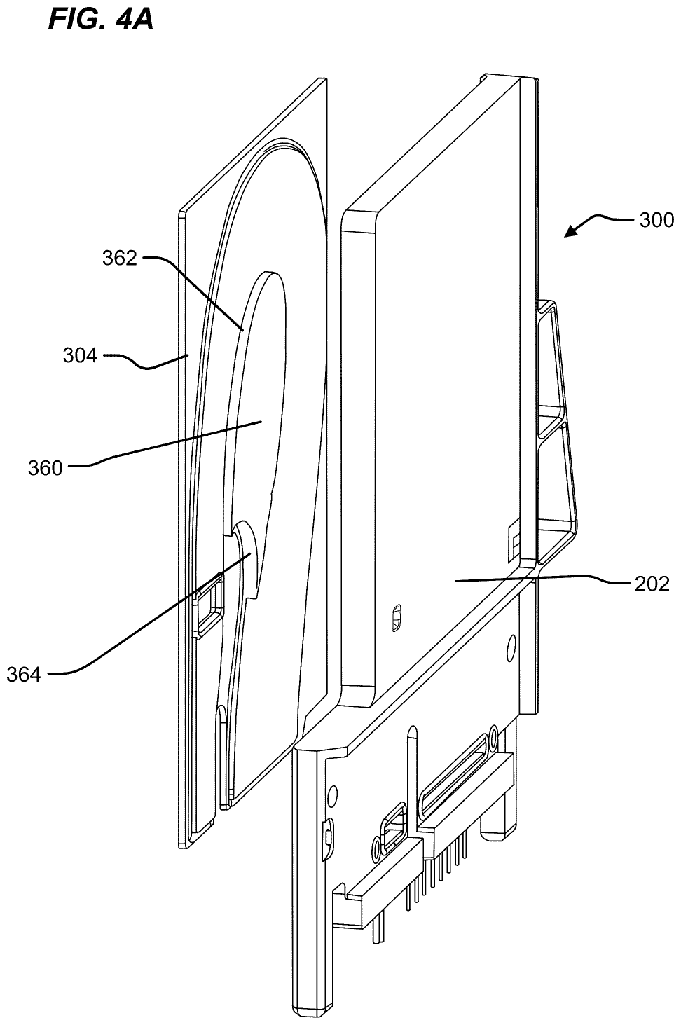

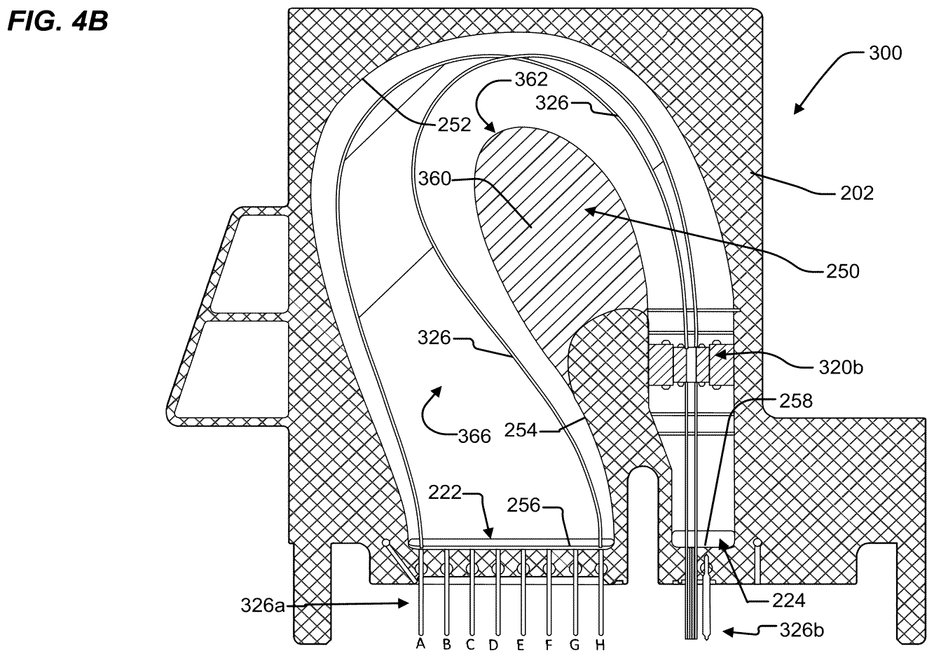

FIGS. 4A-4B are exploded rear perspective and front views, respectively, of an electrophoresis cartridge 300, in accordance with another example. The base 202 of the cartridge 300 (and components and features related thereto) is configured identically or substantially identically to the base 202 of the cartridge 200 of FIGS. 3A-3B. As such, the features numbered with the prefix “200” are to be considered the same as described in the context of FIGS. 3A-3B. As described below, the cover 304 (and components and features thereof) differ from the features of the cover 204 depicted in the context of FIGS. 3A-3B. As such, the cover 304 and features and components thereof are numbered with the prefix “300” in FIGS. 4A-4B. Certain aspects of those features are similar to those of the corresponding features described in the context of the cover 204 of FIGS. 2A-3B, but relevant differences are nevertheless noted in the following description. Other relevant differences between the cartridge 200 and cartridge 300 (e.g., such as lengths of the capillaries) are also noted.

FIGS. 4A-4B are described concurrently and not every feature is depicted in both figures. Further, certain features beginning with “200” are described in more detail with regard to FIGS. 2A-2B above. The cartridge 300 includes a base 202 and a cover plate 304 secured thereto in a liquid-tight manner, e.g., via mechanical, chemical, friction fit, or other fasteners or combinations thereof. The base 202 defines a cavity 250 that is defined at least in part by an outer curved wall 252, an inner curved wall 254, an inlet wall 256, and an outlet wall 258. The heights of the various walls are generally consistent between the base 202 and cover plate 304; thus, the various walls, base 202, and cover plate 304 define a cavity volume of the cavity 250. A volume displacement structure 360 projects from the cover plate 304 and has a height substantially consistent with that of the various walls of the cavity 250. Thus, the volume displacement structure 360 projects into the cavity 250, so as to fill a portion of the cavity volume. This reduces the total volume available for coolant liquid flow within the cavity 250 and, depending on the configuration of the volume displacement structure 360, can ensure a relatively consistent coolant liquid flow at various locations distant from the inlet wall 256 (which is located proximate the inlet 222). Outlet wall 258 is located proximate the outlet 224.

In FIGS. 4A-4B, the volume displacement structure 360 is defined by a first wall 362 and a second wall 364. With the cover plate 304 secured to the base 202, the first wall 362 defines an innermost extent of coolant liquid flow within the cavity 250, while the second wall 364 is adjacent a portion of the inner curved wall 254. In FIG. 4B, the first wall 362 is depicted as a dashed line. Thus, in the cartridge 300 of FIGS. 4A-4B, the first wall 362, a portion of the inner curved wall 254, the outer curved wall 252, the inlet wall 256, and the outlet wall 258 define a coolant liquid flow path 366 having a liquid flow path volume that is less than the cavity volume. Capillary inlets 326a (labeled A-H) are depicted, as are bundled capillary outlets 326b. Within the coolant liquid flow path 366, only two of the eight capillaries 326 are depicted for clarity and each capillary 326 has a nominal length of about 50 cm. As can be seem most prominently in FIG. 4B, the coolant liquid flow path 366 decreases in width from the inlet wall 256 (proximate the inlet 222) towards the outlet wall 258 (proximate the outlet 224). As the height of the coolant liquid flow path 366 is generally consistent along the entire volume thereof (between the base 202 and the cover plate 204), and the volumetric flow of coolant liquid remains constant, the velocity of the coolant liquid increases from the inlet 222 to the outlet 224. As the capillaries 326 are disposed closer together further along their lengths (e.g., towards the outlet 224), this increased coolant liquid velocity helps control temperature within the cartridge 300 and at each of the capillaries 326. FIGS. 4A-4B also depict the observation/detection window 320b, details of which are described further below. It should be noted, however, that the capillaries 326 are disposed adjacent to each other at the observation window 320b, with axes thereof substantially aligned along a single plane. At this location, the coolant liquid flow path 366 is fairly narrow, helping to ensure high speed coolant liquid flow at this location.

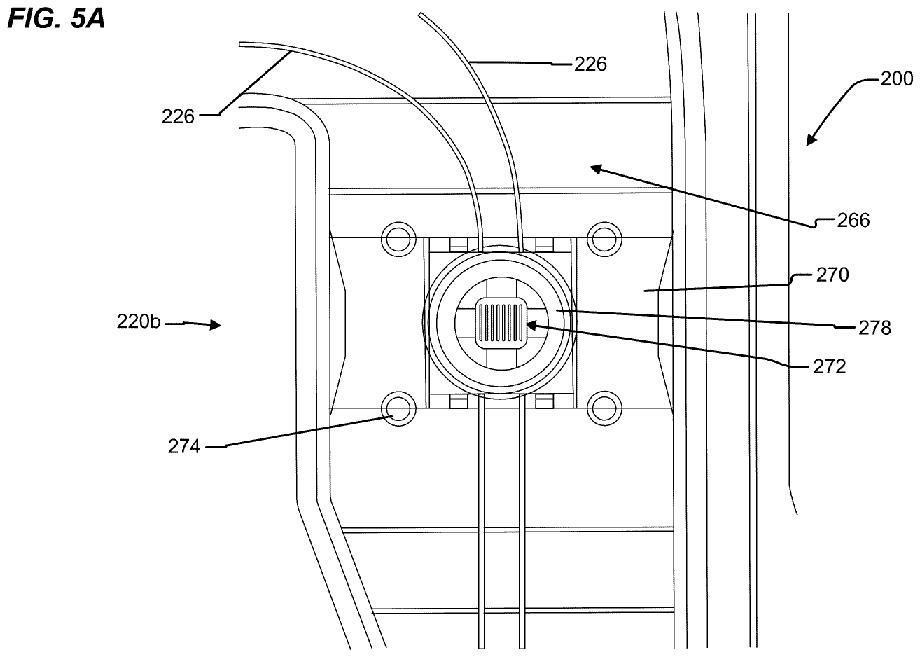

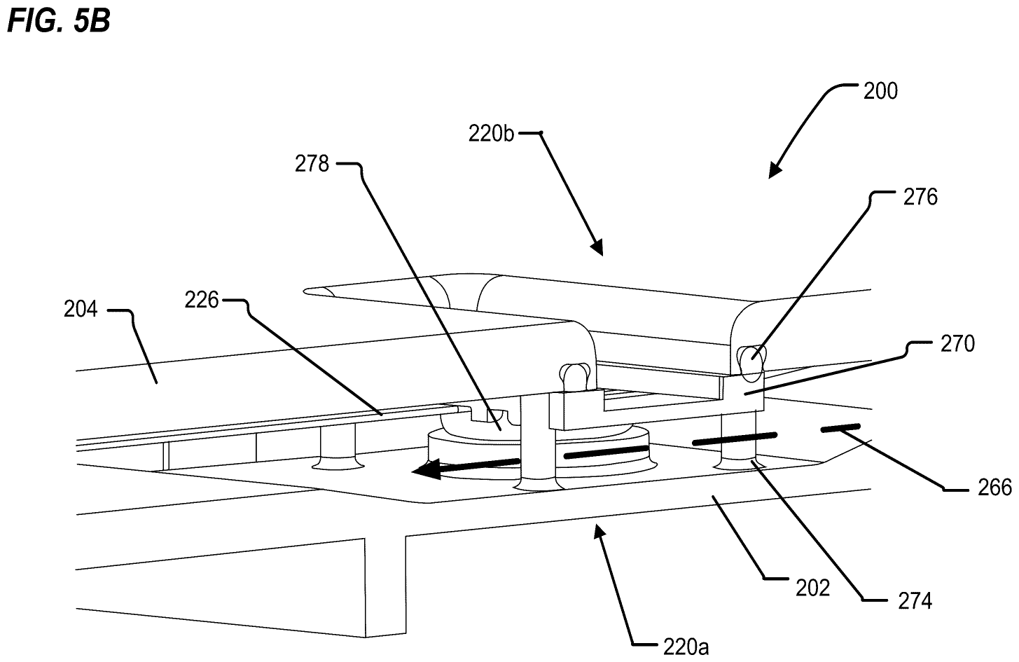

FIG. 5A is an enlarged partial view of a detection window 220b portion of the electrophoresis cartridge 200 of FIGS. 2A-3B, while FIG. 5B is an enlarged partial perspective sectional view of the detection window 220b portion of that electrophoresis cartridge 200. FIGS. 5A and 5B are described concurrently and not every element is depicted in both figures. Further, a number of elements of FIG. 5A are shown partially transparent for visibility. While FIGS. 5A-5B depict the detection window 220b for the cartridge 200, similarities with the detection window 320b of the cartridge 300 of FIGS. 4A-4B would be apparent to a person of skill in the art.

Within the detection window 220b, the capillaries 226 are spaced, in one example, at 500 μm center-to-center on a V-groove chip 270. The V-groove chip 270 defines a plurality of chip windows 272, typically one for each capillary 226, though a greater number of chip windows 272 than capillaries 226 may be utilized, certain of those chip windows 272 may be not used. In examples, the chip windows 272 are rectangular with a height of about 3 mm or about 5 mm (along an axis of each capillary 226), and having a width of about 110 μm, about 100 μm, or about 90 μm. The chip windows 272 allow for observation and imaging of the portion of the capillary 226 (and fluids therein). The V-groove chip 270 defines a plurality of parallel grooves (parallel to the chip windows 272) that support and space apart the capillaries 226. The V-groove chip 270 may be manufactured in whole or in part of thermally-conductive material that helps transfer heat. The V-groove chip 270 may be thin, for example, configured in a thin wafer form factor. The V-groove chip 270 is spaced apart from the base 202 by a plurality of struts 274, which allow the coolant liquid flow path 266 to pass below and adjacent the V-groove chip 270, helping again to transfer thermal energy therefrom (as depicted by the dashed line). The V-groove chip 270 is sealed to the cover plate 204 by at a gasket or seal 276 at the detection window 220b. Similarly, a gasket or seal 278 seals the V-groove chip 270 to the base 202 at the excitation window 220a.

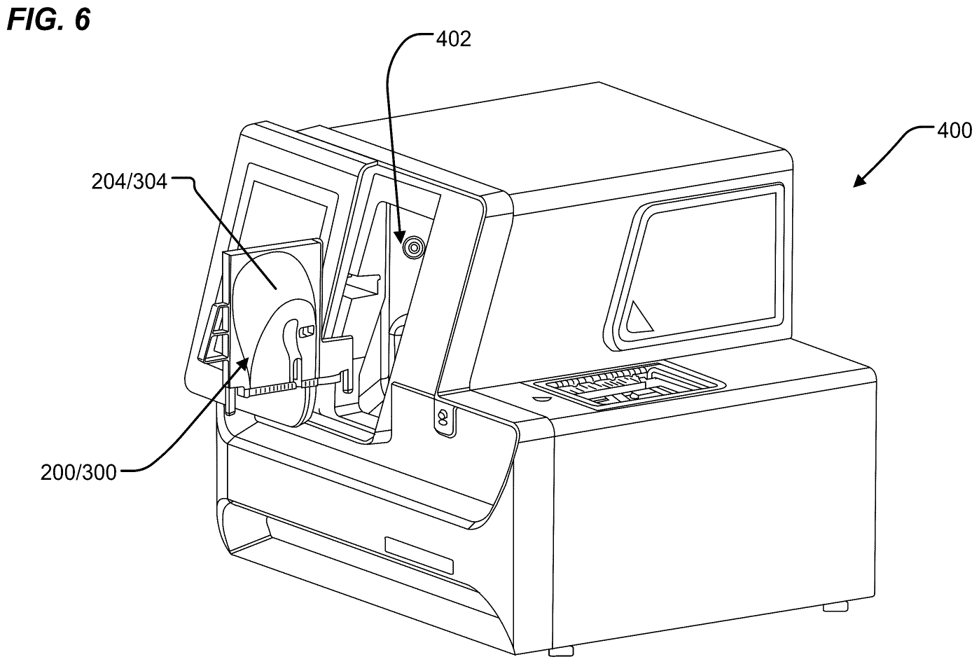

FIG. 6 is a perspective view of an analysis instrument 400 receiving a cartridge, such as one of the cartridges 200 or 300 described herein. It should be noted that the cartridge 200/300 is being inserted into a door 402, such that the cover 204/304 faces the viewer and the base 202 (not visible) faces away from the viewer. The analysis instrument 400 may be a system or instrument for electrophoresis, such as the BioPhase 8800 system (SCIEX), or a similar system.

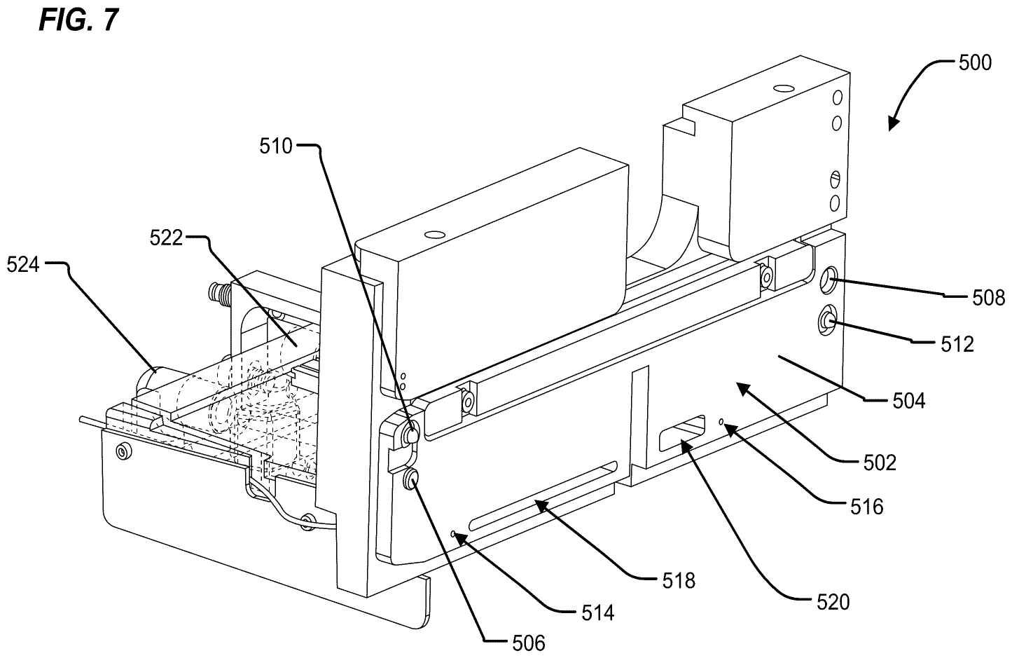

FIG. 7 is a partial view of a dock 500 for an analysis instrument, such as the instrument of FIG. 6. In FIG. 7, the dock 500 is oriented such as it would be in the analysis instrument depicted in FIG. 6. As such, an engaging surface or face 502 of an interface plate 504 of the dock 500 would abut the base 202 of the cartridge 200/300 (as depicted in FIG. 6) once it is fully inserted into the instrument. The engaging surface or face 502 also includes a number of features designed to mate with corresponding features on the cartridge 200/300. For example, a male separation feature 506 (e.g., in the form of a post or protrusion) may extend from the face 502 to mate with the female separation feature 210 on the cartridge 200/300. A female separation feature 508 is configured to mate with the corresponding male separation feature 208 on the cartridge 200/300. Further, a forward detent pin 510 and a rearward detent pin 512 each provide a spring force away from the face 502 to maintain clearance with the rear surface of the base 202 of the cartridge 200/300 during insertion or removal from the instrument. When the cartridge 200/300 is locked into the instrument, the detent pins 510, 512 are compressed.

The engaging surface or face 502 of the interface plate 504 also define a plurality of openings that enable fluidic communication with corresponding ports on the cartridge 200/300. For example, air supply port 514 will fluidically couple to inlet air port 216 on the cartridge 200/300, while air return port 516 will fluidically couple to outlet air port 218 on the cartridge 200/300. A coolant liquid supply port 518 will fluidically couple to the coolant liquid inlet 222 and a coolant liquid return port 520 will fluidically couple to the coolant liquid outlet 224. Gaskets at all interfaces will seal the connections and, as noted elsewhere herein, such gaskets may be disposed on either or both of the cartridge 200/300 and the interface plate 504. The coolant liquid return port 520 is fluidically coupled to a coolant liquid return conduit 522 (only a portion of which is shown in FIG. 7), while the coolant liquid supply port 518 is fluidically coupled to a coolant liquid supply conduit 524.

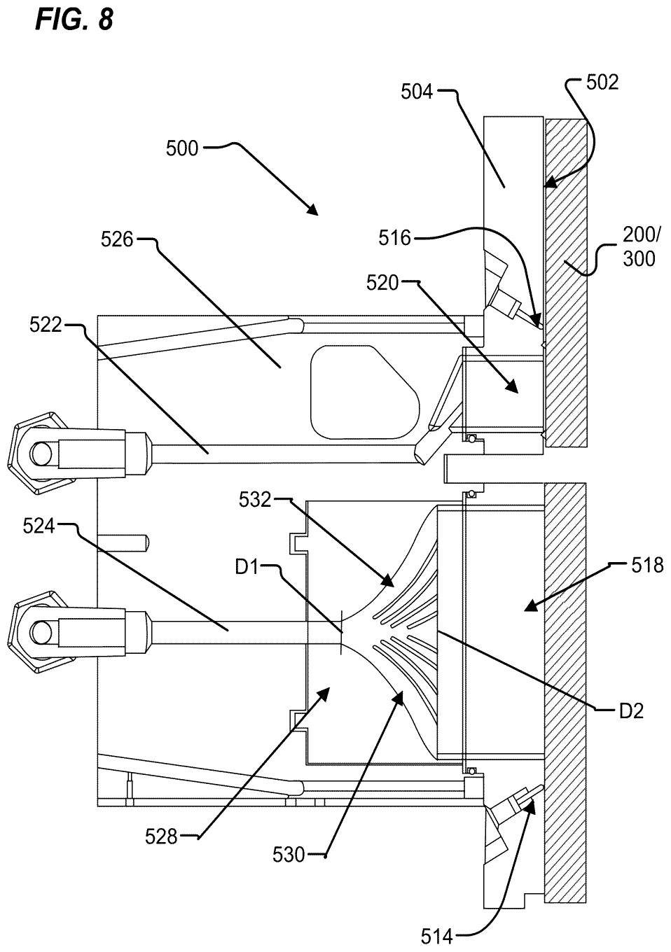

FIG. 8 is a top sectional view of the dock 500 of FIG. 7. A number of features depicted in FIG. 8 are described above in the context of FIG. 7 and therefore are not necessarily described further. In FIG. 8, the cartridge 200/300 abuts the engaging surface or face 502 of the interface plate 504. In doing so, the air return port 516, coolant liquid return port 520, coolant liquid supply port 518, and air supply port 514 are fluidically coupled with their corresponding openings on the cartridge 200/300. Each of these four ports are formed in the dock 500, e.g., in the interface plate 504. Adjacent this interface 500 is a dock body 526, which in examples, may be a unitary part, formed via machining, injection molding, 3D printing, combinations thereof, or other known processes. The dock body 526 defines, at least in part, the coolant liquid return conduit 522 and the coolant liquid supply conduit 524. Between the coolant liquid supply port 518 and the coolant liquid supply conduit 524 is disposed a flow distributor 528 fluidically coupled to both elements. The flow distributor 528 may be integrally formed in the dock body 526 or may be discrete therefrom and fluidically coupled to the coolant liquid supply port 518 and the coolant liquid supply conduit 524.

The flow distributor 528 may have an inlet end dimension D1 proximate the liquid supply conduit 524 substantially similar to that of the coolant liquid supply conduit 524. The flow distributor 528 may also have an outlet end dimension D2 proximate the coolant liquid supply port 518 substantially similar to that of the port 518, and wider than dimension D1. A plurality of vanes 530 are disposed within the flow distributor 528 and aid in distributed flow of the coolant liquid within the distributor, such that the flow of coolant liquid is substantially similar across the entire width thereof. Each of the vanes 530 extend from a bottom surface or floor 532 of the flow distributor 528 to an upper surface of roof (not shown, as FIG. 8 is in section) of the flow distributor 528. In examples, the vanes 530 may contact both the floor 532 and the roof of the flow distributor 528 along their entire lengths. As can also be seen in FIG. 8, an even number of vanes 530 are utilized, though other numbers of vanes are contemplated. Flow distribution is improved by having pairs of the plurality of vanes terminate different distances from the inlet end of the flow distributor 528. For example, leading ends (in a flow direction) of the outermost vanes 530 terminate a first distance from the inlet end, while leading ends of the innermost vanes 530 terminate a second distance from the inlet end that is greater than the first distance. As can be seen, trailing ends of the vanes terminate at a substantially similar distance from the outlet end.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A cartridge for capillary electrophoresis comprising:
a housing comprising:
a base at least partially defining a cavity defining a cavity volume;
a cover plate secured to the base, wherein the cover plate defines a window; and
a volume displacement structure projecting from at least one of the base and the cover plate and into the cavity when the cover plate is secured to the base, wherein the volume displacement structure and cavity together at least partially define a coolant liquid flow path having a coolant liquid flow path volume less than the cavity volume; and
a plurality of capillaries disposed in the coolant liquid flow path, wherein each of the plurality of capillaries comprises a capillary inlet and a capillary outlet projecting from the base.

2. The cartridge of claim 1, wherein the cavity is defined by an outer curved wall.

3. The cartridge of claim 1, wherein the volume displacement structure projects from the cover and is disposed adjacent the outer curved wall.

4. The cartridge of claim 1, wherein the volume displacement structure projects from the cover and is spaced apart from the outer curved wall.

5. The cartridge of claim 1, further comprising a thermally-conductive chip aligned with the window, wherein the thermally-conductive chip defines a plurality of grooves, wherein each of the plurality of grooves is configured to receive one of the plurality of capillaries.

6. The cartridge of claim 5, wherein the thermally-conductive chip is spaced apart from the base so as to form at least a portion of the coolant liquid flow path between the base and the thermally-conductive chip.

7. The cartridge of claim 1, wherein the base further defines a coolant liquid inlet in fluid communication with the cavity and a coolant liquid outlet in fluid communication with the cavity.

8. The cartridge of claim 1, wherein the coolant liquid flow path defines a substantially consistent height between the base and the cover plate.

9. The cartridge of claim 1, wherein the coolant liquid flow path defines a width in a direction substantially orthogonal to the height, and wherein an inlet width proximate the coolant liquid inlet is greater than an outlet width proximate the coolant liquid outlet.

10. The cartridge of claim 1, further comprising at least one detent projecting from the base.

11. A system for supplying liquid to an electrophoresis cartridge, the system comprising:
a dock comprising:
a coolant liquid supply conduit;
a flow distributor fluidically coupled to the coolant liquid supply conduit, wherein the flow distributor comprises a plurality of vanes;
a coolant liquid return conduit; and
an interface plate for interfacing with the electrophoresis cartridge, the interface plate comprising:
a face for contacting the electrophoresis cartridge;
a coolant liquid supply port defined by the face and in fluid communication with the flow distributor; and
a coolant liquid return port defined by the face and in fluid communication with the coolant liquid return conduit.

12. The system of claim 11, wherein the coolant liquid supply port is adjacent the coolant liquid return port.

13. The system of claim 11, wherein the flow distributor comprises an inlet end comprising an inlet width and an outlet end comprising an outlet width.

14. The system of claim 11, wherein each of the plurality of vanes comprise a leading end and a trailing end.

15. The system of claim 14, wherein the leading ends of at least two of the plurality of vanes are disposed different distances from the inlet end.

16. The system of claim 14, wherein the trailing ends of a plurality of the plurality of vanes are disposed at substantially similar distances from the outlet end.

17. The system of claim 11, wherein the flow distributor comprises an upper surface and a lower surface, and wherein each of the plurality of vanes contact both the upper surface and the lower surface along an entire length of each of the plurality of vanes.

18. The system of claim 11, wherein the flow distributor comprises a unitary part disposed in the dock.

19. The system of claim 17, wherein the unitary part defines the coolant liquid supply conduit and the coolant liquid return conduit.

20. The system of claim 11, wherein a width of the outlet end of the flow distributor is greater than a width of the inlet end of the flow distributor.
